(19) United States
(12) Patent Application Publication
(10) Pub. No.: US 2008/0025144 A1
(43) Pub. Date: Jan. 31, 2008

(54) In-line mixing system and method

(75) Inventors: Tony Kocienski, Rochester, NY (US); Steve Markle, Holley, NY (US); Ron Metz, Batavia, NY (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corportation

(21) Appl. No.: 11/496,235

(22) Filed: Jul. 31, 2006

(51) Int. Cl. B01F 5/12

(52) U.S. Cl. 366/270

(57) ABSTRACT

A mixing apparatus has a vessel for containing material to be mixed has an inlet and a outlet and a driven impeller shaft inside the vessel. A first axial direction impeller is at a first axial position on the shaft; and a second axial direction impeller at a second axial location on the shaft. The first and second impellers are configured to pump in opposite directions from each other so that material is between is pumped between the impellers towards the other impeller.

### FIELD OF THE INVENTION

The invention pertains generally to mixing devices and mixing methods. More particularly, the invention in some preferred embodiments, relates to continuous process in-line mixing systems.

### BACKGROUND OF THE INVENTION

Mixing systems are in wide use in industry, for example in the industrial, food processing, paint and pharmaceutical industries. One type of mixing system is a batch mixing system in which a vessel is filled with a material to be mixed, and a shaft with rotating impellers mixes the material in a batch. When the mixing is completed, the vessel is emptied.

Another type of mixer is a continuous process mixer, in which the vessel has both an inlet and an outlet and material is constantly supplied to the inlet and correspondingly goes out of the outlet in a mixed state. In some instances the vessel may have one or more chambers having different types of impellers therein.

The above described mixers have been generally satisfactory. However, in the case of some specialized materials, it would be desirable to have a compact and convenient system that can treat these materials as desired. It also desirable for such a mixer to have clean-in-place (CIP) capabilities so that it can be cleaned simply by applying a cleaning solvent and or flushing without requiring disassembly of the mixing system.

### SUMMARY OF THE INVENTION

The foregoing needs are met, to a great extent, by the present invention, wherein in one aspect an apparatus is provided that in some embodiments provides an in-line mixer which provides a mixing system and method that has a plurality of chambers having different impeller types. In one embodiment, one chamber has a pair of opposed direction impellers axially spaced apart from each other.

In accordance with one embodiment of the present invention, A mixing apparatus, comprising: a vessel for containing material to be mixed having an inlet and a outlet; a driven impeller shaft inside the vessel; and a first axial direction impeller at a first axial position on the shaft; and a second axial direction impeller at a second axial location on the shaft, wherein the first and second impellers are configured to pump in opposite directions from each other so that material is between is pumped between the impellers towards the other impeller.

In accordance with another embodiment of the present invention, A mixing apparatus, comprising: means for containing material to be mixed having an inlet and a outlet; impeller driving means; and a first axial direction impeller at a first axial position on the driving means; and a second axial direction impeller at a second axial location on the driving means, wherein the first and second impellers are configured to pump in opposite directions from each other so that material is between is pumped between the impellers towards the other impeller.

In accordance with yet another embodiment of the present invention, A mixing method, comprising: loading material to be mixed into a vessel having an inlet and a outlet; driving an impeller shaft inside the vessel; and wherein the driving step includes rotating a first axial direction impeller at a first axial position on the shaft and rotating.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross sectional layout view illustrating a preferred embodiment of the present invention, by which an in-line magnetically driven mixer is provided having multiple chambers, with opposed direction axial impellers in one of the chambers.

### DETAILED DESCRIPTION

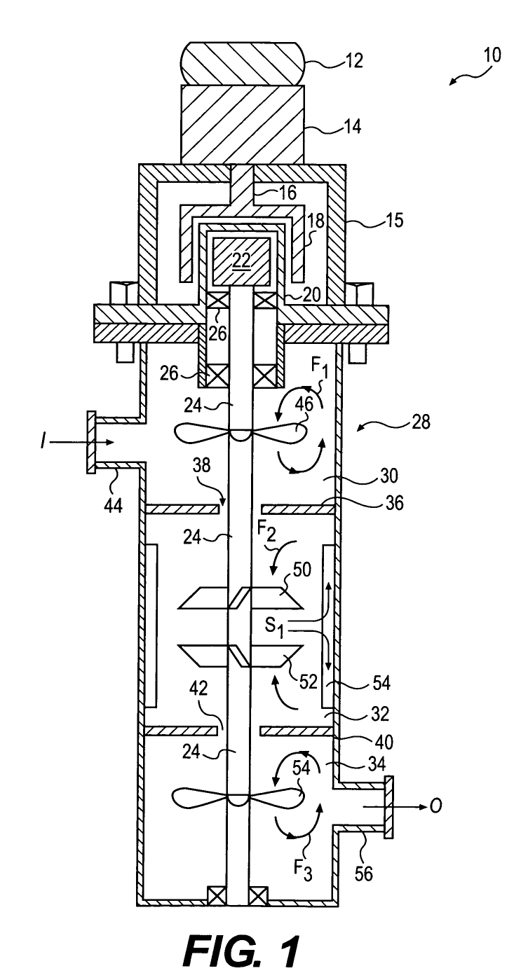

Preferred embodiments of the the invention will now be described with reference to the drawing figures, in which like reference numerals refer to like parts throughout. An embodiment in accordance with the present invention provides a mixing system and method which has a plurality of chambers having different impeller types. FIG. 1 is a cross sectional layout view illustrating a preferred embodiment of the present invention. An in-line magnetically driven mixer is provided having multiple chambers, with opposed direction axial impellers in one of the chambers. The drawing figure is a layout type view, similar to a cross sectional view but with the cross hatching omitted for clarity.

A mixing system 10 is provided by an embodiment of the present invention. The mixing system 10 includes a motor 12, which is typically an electrically powered motor, which drives a gear box or gear reducer 14. An output shaft 16 of the gear box or gear reducer 14 includes an outer magnetic rotor 18 driven by the output shaft.

The gear box 14 is supported by a housing 15. In the illustrated preferred embodiment, an output shaft 16 from the gear box or gear reducer 14 is coupled to a magnetic drive system which permits the mixing vessel to be sealed and have clean-in-place capability (CIP). The output shaft 16 leads to an outer magnetic rotor 18. The outer magnetic rotor 18 is spaced apart from and surrounds a containment shell 20 which has a dome-like canister shape. Inside of the containment shell 20 is an inner magnetic rotor 22.

Rotation of the outer magnetic rotor 18 causes a rotating magnetic field that in turn rotates or drives the inner magnetic rotor 22. The inner magnetic rotor 22 is affixed to the top end of an impeller shaft 24. The impeller shaft 24 is supported by two or more sets of bearings 26. The bearings 26 in this embodiment come in contact with the material to be mixed, and these are so-called wet running bearings. In some preferred embodiments, the bearings 26 may be made of an all ceramic material to improve performance and/or cleanability. However, in other embodiments the bearings may be any suitable commercial bearings.

The vessel 28 generally has three partitioned chambers 30, 32, and 34. The chambers 30 and 32 are separated from each other by a divider wall 36 which has an aperture spacing or orifice 38 between the end of the divider wall 36 and the impeller shaft 24 that is selected to be of a size to control flow through the orifice between the chambers 30 and 32. A larger orifice 38 will increase the possible flow rate from one chamber to the other, while a smaller orifice 38 will reduce the flow rate. This in turn will control the degree of residence time and mixing time of the material in each of the chambers.

Similarly, a plate 40 separates the chambers 32 and 34 and plate 40 has an orifice 42 that also has a preselected size similar to as described above with respect to the orifice 38.

Material to be mixed is pumped, typically via an upstream pump, so that it enters the chamber 30 via an inlet fitting 44 and flows as indicated by the arrow labeled I. In the first chamber 30, a downward pumping high efficiency axial flow impeller 46 is provided mounted to the larger shaft 24. This high efficiency downward pumping axial flow impeller causes an overall flow pattern generally labeled F1 in the chamber 30. The material is treated to general mixing in the chamber 30 and the different components of the material to be mixed tend to become blended into a consistent mixture. Next, the consistently mixed material flows the downward through the orifice 38 and into the chamber 32.

Inside the chamber 32 are two opposed direction impellers 50 and 52. One is a downward pumping high solidity axial impeller 50. The other is an upward pumping high solidity axial impeller 52 spaced axially apart from the impeller 50. Both impellers 50 and 52 be mounted to the impeller shaft 24. It can be appreciated that since the impellers 50 and 52 are opposed to each other, and pump in opposite directions towards each other, and are axially spaced apart from each other, there is a region between the impellers labeled S1 that is a region of somewhat or very high shear for the material.

The application of high shear is desirable in certain applications in order to treat the material in some desirable way, for example by breaking down components of the material into sub components, applying heat to the material, accomplishing greater mixing of the material, and/or other reasons. A flow pattern F2 develops where the material exits the high shear region and then curves upwardly and downwardly along the side of the chamber 32 as shown.

The shear effect can be enhanced in some embodiments by the provision of a number of circumferentially spaced longitudinal inwardly protruding baffles 54. The baffles 54 help direct energy into the desired flow pattern and reduce swirling of the material in the chamber 32. Because the impellers 50 and 52 impart a high shear energy to the material, the baffles 54 may be more necessary in chamber 32 than they would be in chambers 30 or 34. However, chambers 30 and 34 can also feature baffles in embodiments where this is helpful.

After being treated by the opposing high solidity axial impellers 50 and 52, the material exits the chamber 32 via the orifice 32 and enters the chamber 34. The chamber 34 includes a high efficiency axial flow downward direction impeller 54, mounted to the impeller shaft 24, which may be identical to, or similar to impeller 46. The impeller 54 provides further mixing of the material, which may have been broken down or otherwise treated to some extent by the impellers 50 and 52. The result of the mixing action of the impeller 54, which creates a flow pattern F3, is that the material is eventually discharged by the head or pump pressure that was applied at the inlet, so that the fully mixed and treated material flows out via an outlet 56 on the path indicated by the arrow labeled O.

It will be appreciated that this preferred embodiment provides a three chambered in-line mixer, (i) having general mixing done by a single direction axial flow impeller in the first chamber, (ii) having shear applied by opposing axial impellers in the second chamber, and (iii) having subsequent general mixing performed by a single direction axial flow impeller in a third chamber. In some embodiments, it may be possible to eliminate either the first or third chambers or both. That is, in some embodiments it may be desirable simply to achieve the shear effect from the opposing impellers. Further, although high efficiency axial flow impellers are described for use in the first and third chambers, and high solidity impellers are described for use as opposing impellers in the second chambers, in some embodiments different impeller types or numbers of impellers may be used in some or all of the chambers.

Further, the preferred embodiment is illustrated using a magnetic drive system. Such magnetic drive systems may be highly desirable where it is desirable to have a clean-in-place (CIP) feature, and/or where it is desirable to be able to service or change out the rotor and gear box without opening the vessel itself. However, in other embodiments of the invention a conventional bearing and seal drive system maybe used in which the impeller shaft projects through a bearing and seal arrangement at the top of some other part of the vessel.

Also, a preferred embodiment is illustrated and discussed as being in a vertical orientation, with the motor and gear box being at the top of the device. However, other embodiments the mixing system may be oriented in other directions including horizontally.

The application of high efficiency mixing impellers in respective chambers, along with high solidity opposed direction impellers in an intermediate chamber, can provide high power and high flow through capability as well as good blending for many products and ingredients. For example, the illustrated embodiment provides quick mixing of multiple ingredients in flow through applications such as food, personal care products, coatings, paint, and pharmaceutical and biotechnology products.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A mixing apparatus, comprising:
a vessel for containing material to be mixed having an inlet and a outlet;
a driven impeller shaft inside the vessel; and
a first axial direction impeller at a first axial position on the shaft; and
a second axial direction impeller at a second axial location on the shaft, wherein the first and second impellers are configured to pump in opposite directions from each other so that material is between is pumped between the impellers towards the other impeller.

2. The apparatus according to claim 1, wherein the vessel comprises a first chamber, a second chamber, and a third chamber, and wherein the first and second impellers are both disposed in the second chambers.

3. The apparatus equivalent to claim 2, further comprising an axial flow third impeller disposed in the first chamber.

4. The apparatus according to claim 3, further comprising an axial flow fourth impeller disposed in the third chamber.

5. The apparatus according to claim 1, further comprising a plurality of longitudinal inwardly extending baffles disposed around the inside of the vessel and spanning axially at least the axial positions of the first and second impellers.

6. The apparatus according to claim 1, further comprising a magnetic drive system mounted to the vessel which drives the impeller shaft.

7. The apparatus according to claim 6, wherein the drive system includes a driven outer magnetic rotor and the impeller shaft has an inner magnetic rotor, and the vessel further comprises a containment shell disposed between the rotors.

8. The apparatus according to claim 3, when the inlet is provided at the first chamber, and the outlet is provided at the third chamber.

9. The apparatus according to claim 3, further comprising:
a first partition that separates the first chamber from second chamber; and
a second partition that separates the second chamber from the third chamber.

10. The apparatus according to claim 9, when each partition comprises a respective orifice that the defines an opening space between the partition and the impeller shaft for material to flow through.

11. The apparatus according to claim 1, when the first and second impellers are high solidity type axial flow direction impellers.

12. The apparatus according to claim 1, when the third and fourth impellers are high efficiency type axial flow direction impellers.

13. A mixing apparatus, comprising:
means for containing material to be mixed having an inlet and a outlet;
impeller driving means; and
a first axial direction impeller at a first axial position on the driving means;
a second axial direction impeller at a second axial location on the driving means, wherein the first and second impellers are configured to pump in opposite directions from each other so that material is between is pumped between the impellers towards the other impeller.

14. The apparatus according to claim 13, wherein the containing means comprises a first chamber, a second chamber, and a third chamber, and wherein the first and second impellers are both disposed in the second chambers.

15. The apparatus equivalent to claim 14, further comprising an axial flow third impeller disposed in the first chamber.

16. The apparatus according to claim 15, further comprising an axial flow fourth impeller disposed in the third chamber.

17. The apparatus according to claim 13, further comprising a plurality of longitudinal inwardly extending baffles disposed around the inside of the ? means and spanning axially at least the axial positions of the first and second impellers.

18. The apparatus according to claim 13, further comprising a magnetic drive system mounted to the vessel which drives the driving means.

19. The apparatus according to claim 16, wherein the drive system includes a driven outer magnetic rotor and the driving means has an inner magnetic rotor, and the vessel further comprises a containment shell disposed between the rotors.

20. The apparatus according to claim 15, wherein the inlet is provided at the first chamber, and the outlet is provided at the third chamber.

21. The apparatus according to claim 15, figure comprising:
a first partition that separates the first chamber from second chamber; and
a second partition that separates the second chamber from the third chamber.

22. The apparatus according to claim 21, when each partition comprises a respective orifice that the defines an opening space between the partition and the driving means for material to flow through.

23. The apparatus according to claim 13, when the first and second impellers are high solidity type axial flow direction impellers.

24. The apparatus according to claim 13, when the third and fourth impellers are high efficiency axial flow direction impellers.

25. A mixing method, comprising:
loading material to be mixed into a vessel having an inlet and a outlet; and
driving an impeller shaft inside the vessel, wherein the driving step includes rotating a first axial direction impeller at a first axial position on the shaft and rotating a second axial direction impeller at a second axial location on the shaft, wherein the first and second impellers are configured to pump in opposite directions from each other so that material is between is pumped between the impellers towards the other impeller.
